(19) United States
(12) Patent Application Publication
(10) Pub. No.: US 2017/0109814 A1
(43) Pub. Date: Apr. 20, 2017

(54) Linket to control mobile deep links

(71) Applicant: Wesley John Boudville, Pesth (AU)

(72) Inventor: Wesley John Boudville, Pesth (AU)

(21) Appl. No.: 14/756,815

(22) Filed: Oct. 19, 2015

(51) Int. Cl. G06Q 30/08; G06Q 30/00; H04L 29/08; G06F 17/30

(52) U.S. Cl. CPC G06Q 30/08; G06F 17/30867; G06F 17/3087; G06Q 30/0185; H04L 67/02

(57) ABSTRACT

Users establish an individual or collective brand that uses their expertise with a mobile app. A linket is a label for a deep link. A deep link is at minimum 2 items. An id of an app. And a network address or domain where the app is run. A Registry maps from a linket to a deep link. A linket can be a user's personal or professional brand, accessible globally. The personal brand can be for her persona in a game if the underlying app is that game. The professional brand can be where she teaches a subject via the app. The owner of a linket can auction off different time or spatial slots. The owner tells the Registry to map from her linket to the winners' linkets for the slots. A user who queries the top level linket at a time in a given time slot and region will get the winner's linket or deep link for that time and region. The slot winner will interact with the user. The owner can subcontract a task, like teaching English as a Second Language, on a global basis. The Registry can offer auction software, for linket owners to easily auction time and spatial slots.

### REFERENCES CITED

“Apps everywhere but no unifying link” by C. Dougherty, New York Times, 5 Jan. 2015.
“Deep linking's big untapped potential” by M. Thomson, VentureBeat.com, 9 Aug. 2015.
“Generating and presenting deep links” by V. Tankovich et al, US Patent Application 20130110815 (Oct. 28, 2011).
“Methods and systems for facilitating an online social network” by C. Evans, US Patent Application 20140089413 (Dec. 6, 2013).
“Text-synchronized media utilization and manipulation based on an embedded barcode” by C. Evans, US Patent application 20130334300 (Mar. 27, 2013).
“Smart link system and method” by J. Chor, U.S. Pat. No. 8,433,800, (28 Feb. 2011).
“Deep linking to mobile applications” by S. Saxena et al US Patent Application 20150154644 (Dec. 2, 2013).
“Deep linking to mobile applications” by S. Saxena et al US Patent Application 20150156061 (Dec. 2, 2013).

### TECHNICAL FIELD

The field is using deep links for mobile apps.

### BACKGROUND

Mobile apps have a distinctive problem. Most are currently standalone programs that often just converse with an app server run by the company that wrote the app. The apps do not have URL links within them. In general, an app from one company does not interact with an app from another company.

Separately, it is much harder for a search engine, which is optimised to search the Web for webpages, to search arbitrary apps. There is no standard syntax equivalent to an URL or URI to enable this.

To enable such and other functionality in mobile apps has been termed ‘deep linking’ within apps. (The term also has an earlier use that refers to standard web pages and URL links within them. This submission does not use that earlier meaning.)

Major companies have several projects aimed at defining deep links. Facebook Corp. has App Links. Google Corp. has App Indexing and Google Intents. Twitter Corp. has App Cards. Apple Corp. has Apple Extensions. Yahoo has 2 US patents pending. There are also several startups, like Bit.ly, Branch Metrics Corp., Button Corp., Quixy Corp., URX Corp., and Tapstream Corp., each with their own initiatives. The syntax and functionality vary between these company specific efforts.

### SUMMARY

Cellphone usage becomes more common globally. The functionality of the cellphone continues to improve. And for many users, the cellphone is their main or only computer. This submission lets users establish an individual or collective brand that uses their expertise with a mobile app, for professional and personal uses.

A linket controls a deep link. It is defined as a label (written in Unicode to support all languages) for a deep link. A deep link is at minimum 2 items. An id of an app and a network address or domain where the app is run. Often the app runs on a mobile device, which is likely to be a cellphone. The address is assigned to the device by the wireless provider or WiFi hot spot. A raw address, in numbers, is hard to remember. And it can change as the user moves. In this sense, a linket functions like a domain name. It is stable and easier to remember. A linket can be written in Unicode, to service all human languages.

A Registry is defined that maps from a linket to a deep link. The analog of the DNS system. But whereas the mapping from a domain to an IP address is expected to be stable over months, the deep link address can change over hours.

A linket can map to another linket, instead of a deep link. The linket acts like a symbolic link in an operating system.

A linket can be a user's personal or professional brand. The former can be for her persona in a game if the underlying app is that game. The latter can be where she teaches a subject via the app.

The owner of a linket can auction off different time or spatial slots. The owner tells the Registry to map from her linket to the winners' linkets for the slots. A user who queries the top level linket at a time in a given time slot and region will redirected to the winner's linket or deep link for that time and region. The slot winner will interact with the user. When the time duration of the slot expires, the winner relinquishes the slot back to the linket owner. Thus the owner can subcontract or sublet a task, like teaching English as a Second Language, on a global basis.

The Registry can offer auction software, for linket owners to easily auction time and spatial slots.

### BRIEF DESCRIPTION OF THE DRAWINGS

FIG. 1 compares deep links in the prior art with our submissions.

FIG. 1A shows the deep link taxonomy.

FIG. 2 shows the Deep Linker.

FIG. 3 shows the linket Registry.

FIG. 3A shows a protocol stack with deep link and linket layers.

FIG. 4 shows data structures for a linket in a Registry.

FIG. 5 shows Jane sending her new device address to the app server and Registry.

FIG. 6 shows a Deep Linker updating app servers with the new device address.

FIG. 7 shows the Registry pinging a linket owner device.

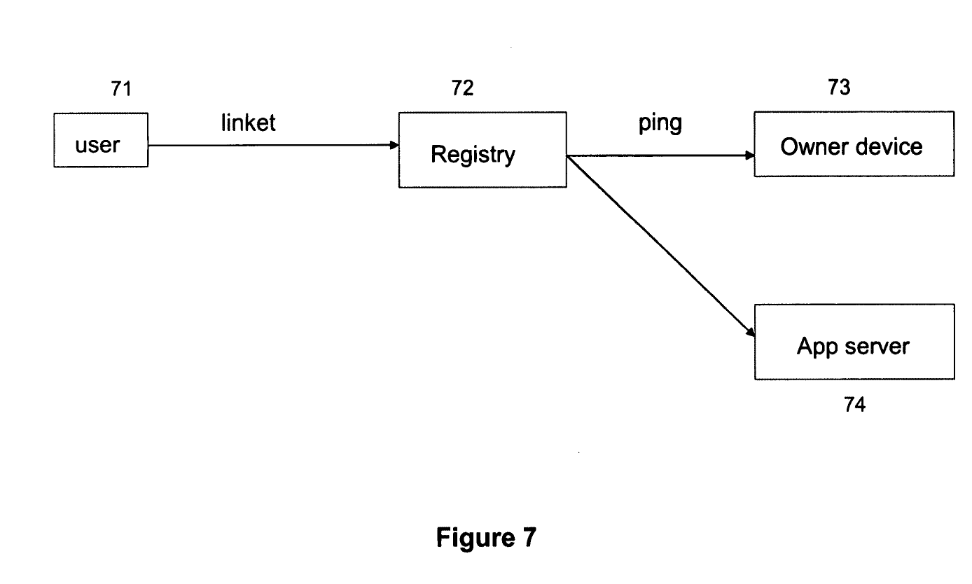

FIG. 8 shows a group of people running the same linket.

FIG. 9 shows an auction in progress for time slots of a linket.

### DETAILED DESCRIPTION OF THE PREFERRED EMBODIMENT

What we claim as new and desire to secure by letters patent is set forth in the following claims. □

This submission refers to our earlier submissions to the US PTO: “Cellphone changing an electronic display that contains a barcode”, filed 16 May 2011, U.S. Pat. No. 8,532,632 [“1”]; “Using dynamic barcodes to send data to a cellphone”, filed 28 Jul. 2011, U.S. Pat. No. 8,348,149 [“2”]; “Transmitting and receiving data via barcodes through a cellphone for privacy and anonymity”, filed 4 Oct. 2011, U.S. Pat. No. 8,707,163 [“3”]; “Colour barcodes and cellphone”, filed 16 Dec. 2011, U.S. Pat. No. 8,821,277 [“4”]; “Mobile device audio from an external video display using a barcode”, filed 25 May 2012, U.S. Pat. No. 8,708,224 [“5”]; “Dynamic group purchases using barcodes”, filed 29 May 2012, U.S. Pat. No. 8,655,694 [“6”]; “Chirp to control devices”, filed 9 Oct. 2012, US patent application 20140098644. [“7”]; “Barcode-based methods to enhance mobile multiplayer games”, filed 22 May 2013, US patent application 20140349746 [“8”]; “Barcode, sound and collision for a unified user interaction”, filed October 2013, US patent application 20150113068 [“9”]; “Deep linking of mobile apps by barcode, sound or collision”, filed Feb. 18, 2015, U.S. patent application Ser. No. 14/544,763 [“10”], “Cookies and anti-ad blocker using deep links in mobile apps”, filed Jun. 8 2015, U.S. patent application Ser. No. 14/545,694 [“11”]; “Blockchain and deep links for mobile apps”, filed Jul. 28 2015, U.S. patent application Ser. No. 14/756,058 [“12”]; “Different apps on different mobile devices interacting via deep links”, filed Aug. 18 2015, U.S. patent application Ser. No. 14/756,208 [“13”].

We filed 4 earlier co-pending US patent applications 10, 11, 12 and 13, for deep links. We described deep links and ways that these could enhance interactions between two mobile devices near each other. The current submission describes a higher level of use of deep links.

We define some terminology.

This submission is mostly about mobile devices carried or worn by people. The most common mobile device is a cellphone. We take this word to also include “smartphone”. The latter term arose to describe a cellphone that also had a camera and Internet access, when such features were relatively new to cellphones. Other types of mobile devices are tablets, laptops, notebooks, netbooks, PDAs and wearable devices.

We will make frequent references to “app store” and “app server”. Despite the similarity in names, these are different entities. An app store is typically run by a maker of a mobile device (like Apple Corp., Microsoft Corp.), or a provider of an operating system for mobile devices (like Google Corp.). Software companies that make mobile apps submit these to an app store. So users can find the apps in the app store and download them to the mobile devices. An app server is a server run by one of those software companies. A mobile user can use her device browser to go to the website of the app server, to download the app.

When we later describe an instance of an app interacting with an instance of another app, we might say, for brevity, a statement like “the first app interacts with the second app”, when strictly it should be “an instance of the first app interacts with an instance of the second app”. There should be no confusion with the use of the shorter phrase. But when 2 instances of an app interact with each other, a more precise phrasing is needed, like “a first instance of the app interacts with a second instance of the app”.

This submission has the following sections.

### 1: Introduction;

### 1.1: Taxonomy of Deep Links;

1.2: Definition of a linket;
1.3: Prior art;
2: Why own a linket;

### 2.1: Auctions;

2.2: Linket pointing to a linket;
2.3: Space and time slots;
3: Format of a linket;

### 1: Introduction;

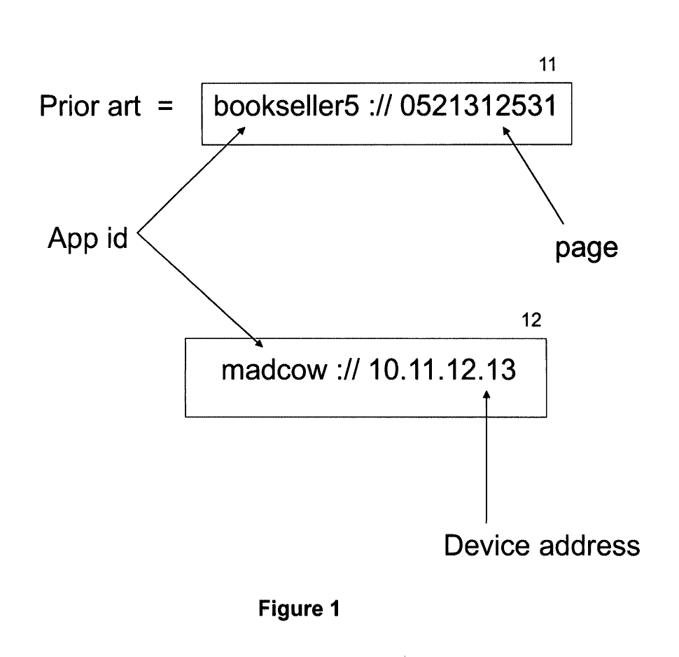

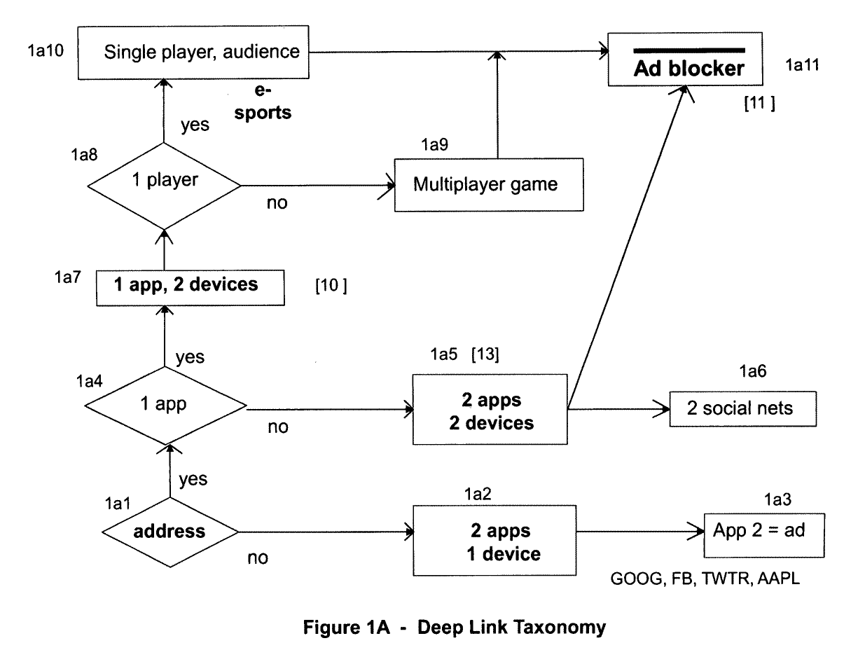

FIG. 1 shows examples of two types of deep links. Item 11 is representative of the prior art and item 2 is a deep link from our previous and present submissions. Item 11 is a deep link that points to an app “bookseller5” made by an online bookseller. The deep link also has an id of an item for sale, given by its ISBN 0521312531. The typical use might be where a user Jane is using her mobile device to run another app, about history, say. While reading the app, it lets her click on a deep link to order a book about a subject described in the app. The deep link is then executed in some manner on her device to install the bookseller5 app, assuming it is not already present. The app is run, with the ISBN as an input parameter, bringing it up at the page/screen specific to that book. Hence the ISBN is a context, making it more useful to Jane, rather than having the bookseller5 app launch and just show its default “home page”. So she saves vital clicks, in not having to type or copy and paste the ISBN from her first app to bookseller5. These are manual and error prone actions on a mobile device.

Another key point is that the apps are made by independent companies.

If we think of the bookseller5 app as a catalog of items for sale, then the ISBN corresponds to the page for an item. Similar to many conventional retail websites.

The preceding is the approach taken because several companies like Google and Facebook are well aware of the importance of ads for making revenue. Not all the prior art efforts use the “://” format, but most do. It is highly evocative of the familiar format of an URL. The point is that given the context of the expertise and revenue sources of the major companies, they have shoehorned the use of deep links into the context of showing ads.

Our submissions do not disagree with the prior art about the importance of showing ads. But we take the approach of item 12. Our deep link can be used for multiuser interactions. The basic use case is a user, Bob, of a mobile device, who has an app, madcow. This might be a multiplayer game. His device has the network address 10.11.12.13. He needs another player or perhaps a spectator. His app instance makes the deep link 12. This combines an app identifier, madcow, with the address of the instance.

Another way of understanding the difference between the deep link prior art and our submissions is via Wikipedia. At this time of writing (September 2015), the Wikipedia entry for “mobile deep linking” starts by saying “deep linking consists of using a uniform resource identifier that LINKS TO A SPECIFIC LOCATION WITHIN A MOBILE APP”. [Our emphasis.] This is a fair summary of the entire computer industry effort on deep links. The location is an id of a data field in the app or in the database of the app server. This data field might be the equivalent of a web page.

In contrast, our submissions use a deep link that LINKS TO A MOBILE APP AT A SPECIFIC NETWORK LOCATION.

The deep link is propagated by various means described in our earlier submissions. For example, Bob might send the deep link in an electronic message to his friends. He might write the deep link in his website. He might post the deep link in a blog or article on a third party website. These methods let him promulgate it to people who are not near him.

For people near him, there are other methods. He might convert the deep link into an audio signal (cf. [7] “Chirp to control devices”). Then his phone plays the audio. Someone nearby can record this with her phone and decode it into the deep link, and then run the deep link. Or he could convert the deep link into a barcode (like a QR code) and show the barcode on the screen of his phone (cf [1]). The person nearby can scan it with the camera of her phone and then decode into the deep link. Or he could upload his deep link to a collision server and then collide his phone with the other person's phone. Both phones use the Bump app that lets her get the deep link by asking the collision server (cf [9]).

Jane gets the deep link by one of those means and wants to play or watch Bob. And by watch Bob, we mean she watches his game play on her device, even and especially if she is in line of sight of him. The method where Bob shows her his screen as he actively plays the game is awkward for both of them, due to the small size of his screen. It is hard for him to play comfortably while doing so. And if there are more people around him who also want to watch, it rapidly becomes impractical for all to look at his screen.

Her device runs a Deep Linker that installs madcow if it is not already present. An instance of madcow is run on her device, with Bob's instance address as input. This tells her instance to go across the network (which we take to be the Internet) and make a connection to Bob's instance at some port number. Bob's instance is listening at this port. Whereupon they play a multiplayer game. Or she can watch him. The latter is an example of e-sports (electronic sports).

### 1.1: Taxonomy of Deep Links;

In computing, the terms virus and worm and used by analogy with their actual biological counterparts. In the same spirit is shown FIG. 1A. A taxonomy of deep links. It classifies apps that use deep links. The apps correspond to species. There is another difference between FIG. 1A and a biological taxonomy. The latter can show extant (living) and extinct species. FIG. 1A shows existing (corresponding to “living”) apps and future apps that use deep links. FIG. 1A is a summary of the co-pending submissions and this submission.

To be explicit, FIG. 1A unifies the prior art of deep links with our deep links.

The title of this sub-section and the title of FIG. 1A refer to a taxonomy of deep links, for brevity. A fuller title might be ‘Taxonomy of apps using deep links’.

FIG. 1A classifies the apps based on a flow chart. Start at item 1a1. We have an app Alpha that runs on a device, Chi. The device can be and probably is mobile. When we say Alpha runs on Chi, to be more precise, we mean an instance of Alpha runs on Chi. This instance has a deep link in it that is executed. Item 1a1 asks if the deep link has a network address of an instance of another app, Beta, running on another device, Kappa. (Kappa is also likely a mobile device.) The format of how this address is written in the deep link is arbitrary, but an example could be item 12 of FIG. 1.

If the answer is no to item 1a1, we go to item 1a2, “2 apps 1 device”. This is the prior art. It means there are 2 apps running on the same device. The first app has the deep link, and executing it caused the second app to be installed and run. In general, the second app can be any type of app. But de facto in most of the cited examples given by competitors, the second app is an ad. This is depicted as item 1a3. “App 2” is the second app and it is an ad.

By items 1a2 and 1a3 are shown the 4 major companies with deep link implementations. Google, Facebook, Twitter and Apple. As depicted by their stock symbols. For brevity, the smaller startups with deep links are not shown.

We stress that to the best of our knowledge, at this time of writing (September 2015), all the prior art resides in item 1a2.

Suppose the deep link of the Alpha instance points to another app instance on another device, so that the answer to item 1a1 is yes. We go to item 1a4, “1 app”. This asks if the apps are the same app. (Alpha=Beta ?) If the answer is yes, then we go to item 1a5, “2 apps 2 devices”. This means we have 2 devices and each device is running an instance of an app, and the apps are different. This scenario was covered in submission 13, as indicated by the label “[13]” by item 1a5. One major use case is when both apps are for different social networks, as indicated by item 1a6.

Now suppose for item 1a4 that the answer is yes. We go to item 1a7, “1 app 2 devices”. This is the important case where there are instances of the same app that are running on 2 devices. The label “[10]” means that submission 10 is mostly about this case.

We go further. Item 1a8 asks if there is “1 player”. This means does the app only have one active user at a time? We use “player” to suggest that the app could be a game, so the user can be called a player. But this is not restrictive. It could be a non-game app.

If the answer is no, we go to item 1a9, for a multiplayer game. Again, we use the terms “player” and “game” for the case where the app is a game. But the app could be a non-game app.

If the answer is yes, we go to item 1a10, “single player, audience”. This is the case of a single player app, where there is only one active player. But there could be several users who are watching. They are the audience. When the app is a game, this can be considered e-sports (electronic sports). This accounts for the label by item 1a10. Item 1a9 for a multiplayer game could also have e-sports, where there are several active players and several watchers.

For item 1a10, a use case where the app is not a game is when the app is educational. Perhaps the single user is going through some teaching app, while the other users are watching and learning. To some extent, calling this a single user app is arbitrary if the app lets the watchers also interact in some non-trivial way. So this can be an instance of item 1a9, considered now as a “multiuser app”, as a generalisation of the “multiplayer game” label.

For items 1a5, 1a9 and 1a10, there is an important ancillary use indicated as item 1a11. An anti-ad blocker. The horizontal bar above the label “Ad blocker” is a Boolean negation, taken to mean anti. This was described in submission 11, and the label “[11]” by item 1a11 indicates this. Our use of deep links can let an app circumvent an ad blocker. More precisely, it lets an instance of an app running on a mobile device get ads even if there is an ad blocker sitting between the app and the rest of the network.

Returning to item 1a1, an app can have different types of deep links. One type given by the prior art and the other type by our submissions. The taxonomy logic can be applied to each deep link in the app. When one deep link is executed, the app instance behaves as in item 1a2. When another deep link is executed, the app instance behaves as in item 1a4. This can be because in the source code or executable, there are hardwired links of both types.

A variant is suppose an instance of an app has only one type of deep link hardwired into it. Like the type in the prior art, for example. But during the running of the instance, it gets another deep link from its server (assuming it uses a server, and most apps do) that is of the type in our submissions. And where, in the running of a different instance of the app, it never gets our type of deep links from the server.

Because of these possibilities, it is more accurate to regard FIG. 1A as a taxonomy of deep links rather than a taxonomy of apps.

### 1.2: Definition of a Linket;

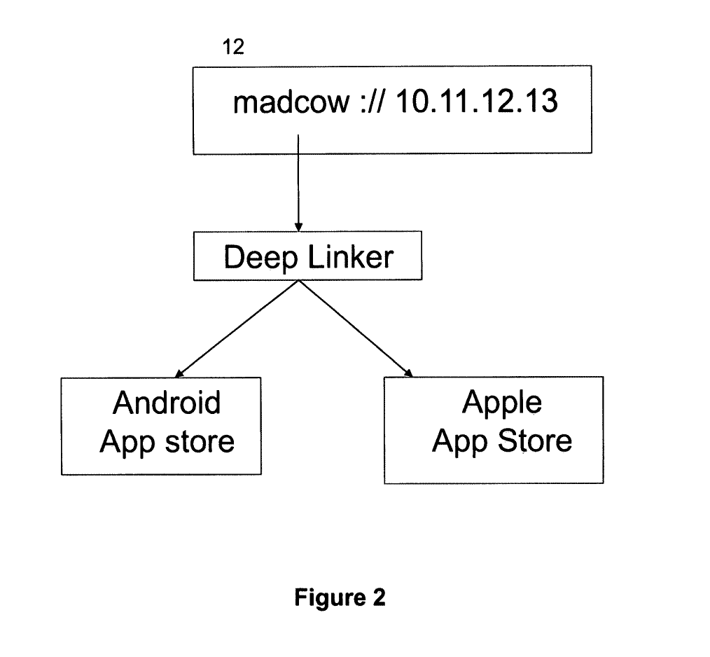

FIG. 2 depicts the Deep Linker taking the app id and searching various app stores for a corresponding app. The Deep Linker functionality can run in several devices. Primarily it is on the mobile device. When it gets a deep link and extracts the app id, it first checks on the device to see if the app is already installed. If so, the Deep Linker runs the app with the address from the deep link as input. Otherwise, the Deep Linker would search an appropriate app store. If the mobile device that got the deep link is an Apple, the Deep Linker would search the Apple app store. Else if the mobile device is Android, the Deep Linker would search the Android app store. And so on for mobile devices running other hardware or operating systems. Plus, there might be several major app stores for a given type of device, so these app stores could also be searched.

The searching of the app stores could be done by a portion of the Deep Linker that runs on an external network address, with a known domain. The Deep Linker would have its server sitting at the domain, and several tasks could be delegated to the server.

Now return to item 12—the deep link. It has a raw network address, written in Internet Protocol version 4 (IPv4). It could also have been written in IPv6 format. The reason for the raw address is that when a mobile device accesses the Internet, it typically does so via one of two ways. Through a wireless carrier, especially if the device is a cellphone. Or through a WiFi hotspot. Or perhaps through wireless means equivalent or analogous to these two. (Like using WiMax.) Or perhaps through wired means. The mobile device might temporarily be connected by a communications cable to a network device like a hub.

For simplicity, item 12 omits a port number. But in general, a port number could be explicitly written. The omission of the port number can be because given knowledge of the app name or id (“madcow” in this example), then when the app is listening, it does so at a default port. Likewise, another instance of the app on another device would know about this default port from its internal logic and data. So it could be omitted in item 12.

The address the device gets is temporary. For the hotspot, the address is valid until the device moves out of range, which might be 100 meters or so. For the wireless carrier, it might be a longer range; over an entire suburb or city.

It might be though that this temporary nature of the network address in the deep link is a disadvantage. What if the user promulgates her deep link and then moves and her device acquires another network address? There are 4 answers to this.

First. She may be at a location long enough to use her current network address. Like if she is in a coffeehouse for an hour and during that hour she wants to interact with others using a deep link that has her network address. Or, as alluded to above, if her address is through her phone carrier, and it will be stable even if she moves through several suburbs.

The coffeehouse example also includes the important sub-case where Jane propagates her deep link to someone near her. He might be in line of sight or his device might be able to record audio coming from her device.

Second. Her device might have an IPv6 address that remains constant even as she moves. One of the advantages of IPv6 is that it has protocols that enable this.

Third. In our previous submission 13, we described the use of transient deep links. If Bob's device gets another address, his madcow app would contact the server. It makes the new address the current address of his instance, and it puts the old address (10.11.12.13) into an associated table. When Jane's device tries to access the now obsolete address 10.11.12.13, after this access fails, her device can ask the madcow app server. The server redirects Jane's device to the latest address at which Bob's instance is listening.

Fourth. A label that remains constant, even as it points to a variable deep link. This is the subject of much of this submission. To be explained below.

Note that for the 4 reasons given above, they are not all mutually exclusive. For example, if the device has a permanent IPv6 address, it might still want to define a label to point to the deep link that uses this IPv6 address.

There is a key issue unaddressed in submission 13. Look again at item 12. The raw address has very little brand value.

We have been here before.

In the 1970s the ARPANET was being built out. The precursor of the Internet. Users soon realised that putting a label in place of a raw address was helpful. The label would have the semantic value of name recognition. Thus arose the domain name system (DNS). All this was in the context of what is by today's standards a tiny user base and tiny number of hosts. And for a network restricted to pure research and development. Overt commercial use was largely restricted for the Internet until the early 1990s. Yet the subsequent dot com boom of the late 90s was due in part to the perceived semantic value of domain names. Business.com, car.com, buy.com etc.

Thus this submission defines a label of a deep link. Analogous to the domain name of an Internet address.

We define a “linket” to be the label of a deep link. (Rhymes with bracelet.) Terminology is arbitrary, but let us motivate this choice. It is short and easy to pronounce. It has “link”, to emphasise the importance of a link or hyperlink. It has no current popular meaning in English. (It has prior meaning in German, Danish and Hungarian.)

En passant, linket allows for a feminine form in French. A female owner of a linket, or the linket itself, might be called a linkette, especially if she uses an app that has a predominantly female audience. (“C′est une linkette” or “This is a linkette”.)

The linket can be expressed in Unicode. This is an improvement over domain names, which for most of their existence have been restricted to ASCII symbols. Using Unicode lets linkets be written in Chinese, Japanese, Hindi, Russian, Arabic, Hebrew and other languages that do not use the Roman alphabet. For Arabic and Hebrew, Unicode also means that the linket can be written and read from right to left. The linket also lets words written in languages that use the Roman alphabet have accent symbols, like the grave and acute of French or the tilde of Spanish.

By using Unicode, the linket is a global standard that does not discriminate in favour of English.

The linket can be case sensitive. Unlike domain names. This improves the readability of expressions. Case sensitivity is moot for languages like Chinese or Hindi which do not have the concept.

The linket can have white space. (See Section 5 for the implications of this.)

If the last 2 reasons are chosen for the linket, then even for ASCII labels, it improves the readability compared to domain names.

There could be different linket formats that are incompatible. While it might be considered better to have only one linket format, this is not a necessity of the submission. So long as parsing routines can detect the formats, then several could be supported in the marketplace. This is a major difference with DNS.

Another difference is that DNS updates the mapping to an IP address roughly on the time scale of one day. The deep link associated with a linket can change its address on a more rapid time scale. Perhaps several times a day, as the linket owner device moves to different locations.

A linket format might have a hierarchy or structured subdivisions, or not. Domains are hierarchical. One linket format could group linkets by language—English, Chinese, etc. Where each language might be considered similar to a Top Level Domain for domain names. This does not imply that the linket format necessarily needs a hierarchical notation with ‘en’ [English], ‘zh’ [Chinese] etc as the top fields. By programmatic means, a text string can be analysed to determine which language it is in, so there might be no need for an explicit notation in the linket.

If a linket uses several languages, this could be considered an intersection of top level groups. This is a multiple inheritance structure, whereas domains are single inheritance. For example, the domain test.co.uk is a child only of co.uk, which is a child only of the .uk TLD.

A significant use case of the linket is to let individuals have a personal brand associated with themselves. This follows the observation that many (most ?) people in many countries now have cellphones. A user's cellphone becomes an extension of himself, as has been observed. It is the most common type of personal computer in the world.

Hence a person can own a linket. (Ditto for a corporation owning a linket.)

Why can't a user then just have his phone number just be his personal brand? Because the digits are not memorable in themselves.

So why can't a user make a conventional domain and make that his brand? He can, and at present that is his main choice. But most cellphones do not have a static (permanent) IP address. So his domain would be hosted at some ISP. Still useful, but it does not take full advantage of his cellphone. With IPv6, one mooted feature is the easier means of a mobile device having a static IP address. But even when IPv6 becomes common, this does not mean that many mobile devices will actually have static IP addresses.

Another problem with a domain is subtler. The domain is typically accessed through a browser, where the domain is part of an URL that is put in the address bar. The domain server returns a web page, currently written in HTML5 (or some earlier version). The web page is meant to used via the user reading the page according to the rules of HTML. The computer industry has already found that for mobile phones, the user experience is better if the interaction is via apps. The apps offer an interaction that can be more closely attuned to the hardware and operating system of the phone. Apps are not constrained by HTML. Thus for mobile phones, the main development effort has shifted from writing web pages optimised for a mobile browser to writing apps.

The linket expresses another trend. A user has a cellphone, but he also uses apps on that cellphone. A linket maps to a deep link, which is an app at a network address. A combination of functionality and address. The linket utility also comes from the observation that for the main apps stores of Apple and Android, there are currently over 1.5 million apps on each.

The linket hides the raw network address. This has 2 advantages. A given network address is a set of digits and hard to remember. And as the user moves, the address can change. All this implies the need and utility of a Registry that maps automatically from the linket label to the deep link.

The changing of the address in the underlying deep link is analogous to how a user who gets a domain and hosts it at a given ISP might move his domain to another ISP. This entails mapping the domain to a new IP address. But users who access the domain via DNS do not have to worry about it. Thus with the linket and its Registry.

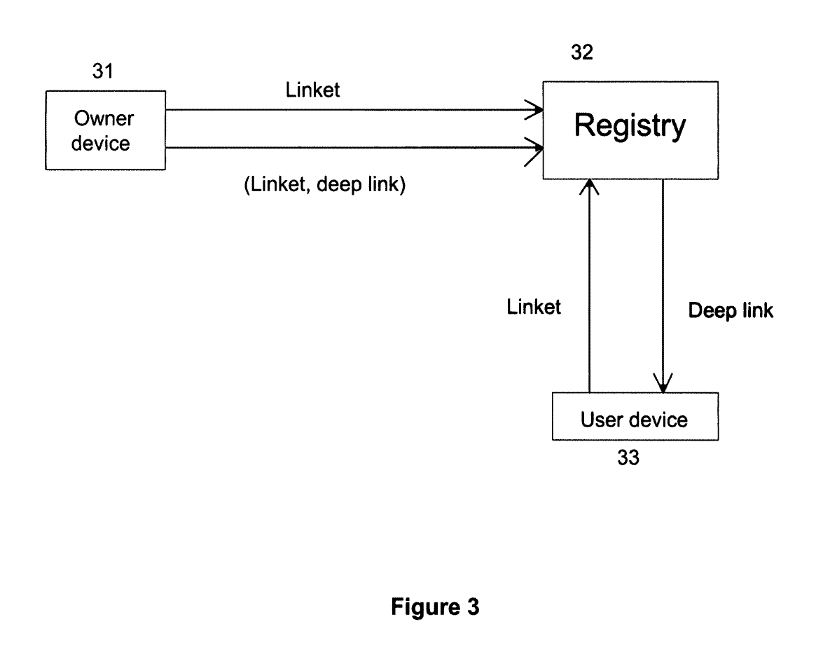

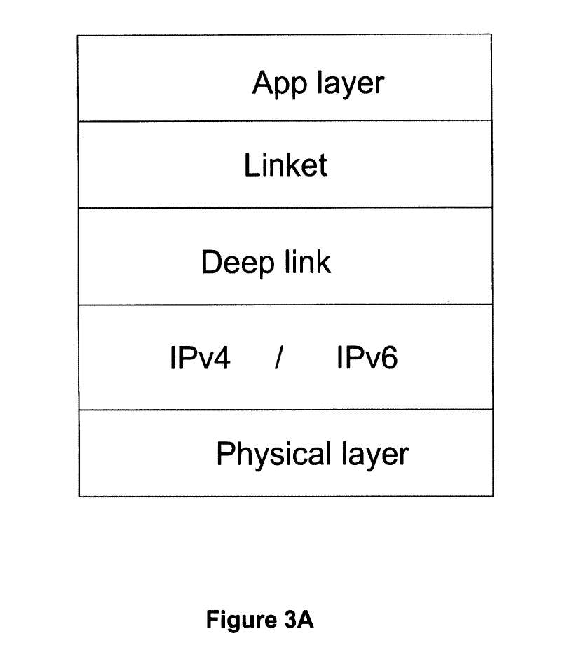

FIG. 3 shows owner device 31. There are 2 modes of operation. In one, the device just uploads a linket to Registry 32. This amounts to the owner applying for ownership of that linket, though she as yet does not have a deep link assigned to it. This is equivalent to the case where a user registers a domain name with a DNS authority or registrar, but has not yet hosted the domain at an ISP that provides an actual IP address. The Registry might charge her a fee for registering the linket.

The other mode of operation has device 31 uploading the ordered pair (linket, deep link) to Registry 32. The user of device 31 is the owner of the linket and the deep link. In general, device 31 need not be the device (whose address is in the deep link) at which her app will be listening. When she does this, she does not necessarily need to have first just applied for the linket in an earlier step. In the current mode, she might also be applying for the linket.

Device 31 does not need to be a mobile device. The owner of the linket might be at her personal computer when she uploads to the Registry. Or she might be at a PC at a library or at work.

The uploading of data about the linket could involve more parameters. Like a hardware id of the device (eg. MacID), that remains stable, unlike the network address. For simplicity this is omitted from FIG. 3.

Suppose the Registry accepts the (linket, deep link) into its database. At some later time, a user device 33 queries the Registry with a linket. The Registry replies with the corresponding deep link. In general, user device 33 is different from device 31. Device 33 does not need to be mobile, though in practice the expected majority of cases is that it will be mobile.

For descriptive simplicity in what follows, we shall write the linket as a string enclosed in quotes. This is meant to describe its string contents in an understandable way that is independent of a choice of format. Section 5 will discuss possible formats.

FIG. 3A shows a simplified protocol stack. This follows the flavour of the OSI protocol stack and the Internet protocol stack. The lowest layer is the physical layer. Above this is what we term the IPv4 or IPv6 stack. In this, we merge the TCP/UDP layer into the IP layer in the standard Internet protocol stack. The next higher layer is where the deep links sit, where the deep link is defined in our previous submissions and this submission. Above this is the linket layer, which points to the deep link layer. The application layer is the top layer.

The apps in the application layer refer to those apps (mostly but not exclusively mobile) that conform to the descriptions of our submissions. An app does not have to access the linket layer, but can go directly to (i.e. use) a deep link, as per our earlier submissions. Also, an app can of course directly access the IPv4 or IPv6 layers or the physical layer. (At least to the extent that the operating system permits.)

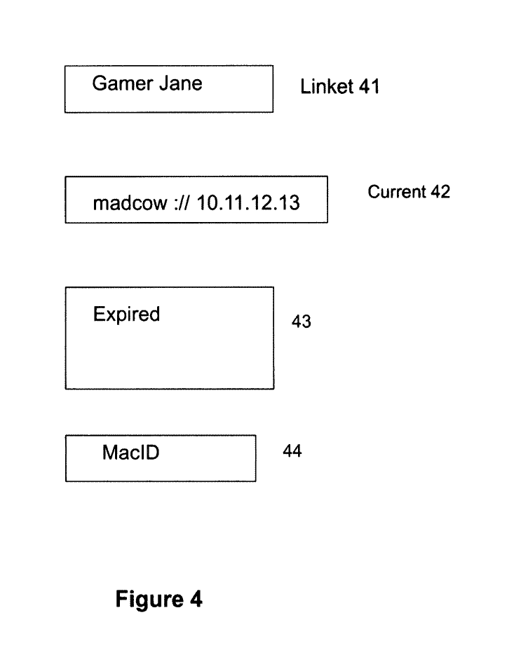

FIG. 4 shows an example of the data structures in the Registry for a linket. Linket 41 has the value “Gamer Jane”. Current 42 is the corresponding deep link. MacID 44 holds the MacID. Expired 43 is explained below. There could be other data structures, perhaps related to the id of the owner. In part because she might have to pay the Registry to get and maintain her linket.

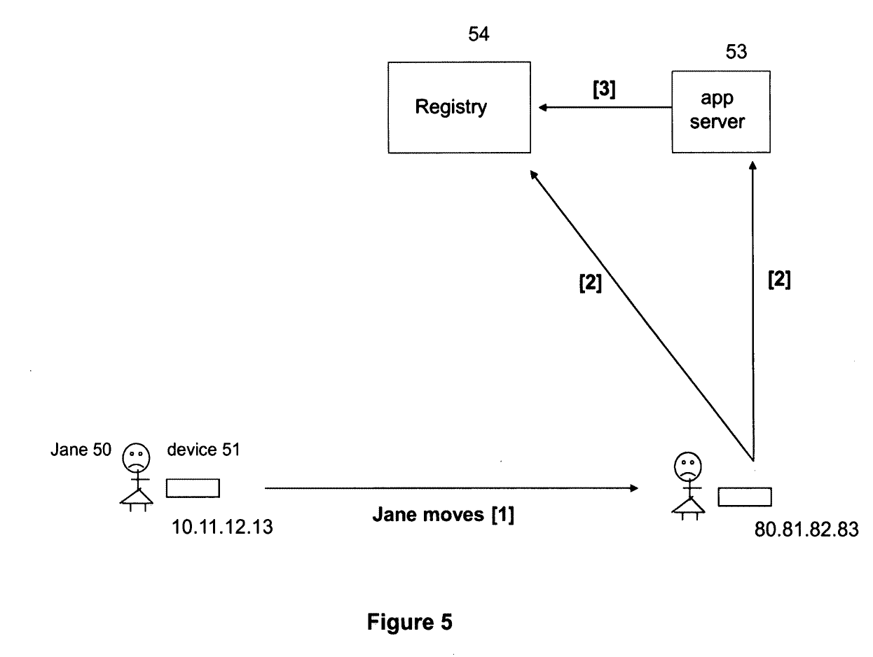

What happens when the address in the deep link changes? When the owner of the deep link moves with her mobile device. FIG. 5 shows Jane 50 and her mobile device 51. It is assumed that the device has the address 10.11.12.13. The label “Jane moves [1]” is for when she moves to a different place and gets the address 80.81.82.83.

One possibility is to suppose that the app in the deep link is running when the device moves. The app can monitor the network address of the device it runs on. When it detects a change, the app automatically contacts the app server and the Registry with the new address. Possibly, the app can also upload the old address, as extra confirmation. In general, of course, the updating procedure has associated steps (probably using cryptography) that let the app confirm to the app server and Registry that it has the authority to ask for these changes.

But what if the app is not running when the mobile device gets a new network address? The Deep Linker on the mobile device could run as a background process (“daemon” in unix or linux machines). It detects that the device network address changed. It has a list of deep links and linkets that should refer to the device. So the Deep Linker tells the app servers and the Registry about the new network address. The steps in this paragraph we attributed to the Deep Linker. They could also be run as part of other system level processes on the device, or perhaps as a separate process.

Both cases are shown as step [2] in FIG. 5. The app or another program on the device sends the new address to the app server 53 and the Registry 54.

Another merit of the updating being done from outside the app is when the device has several linkets pointing to it, referring to different deep links and different apps on the device. If the Deep Linker (or some other program) updates the Registry, it can be more efficient network wise or in terms of saving computations or energy if the updates are batched into a minimal network interaction with the Registry. Roughly, sending or getting a bit across a wireless network can take 10 times more energy compared to doing a computation on a bit on the device, where the computation does not involve the network.

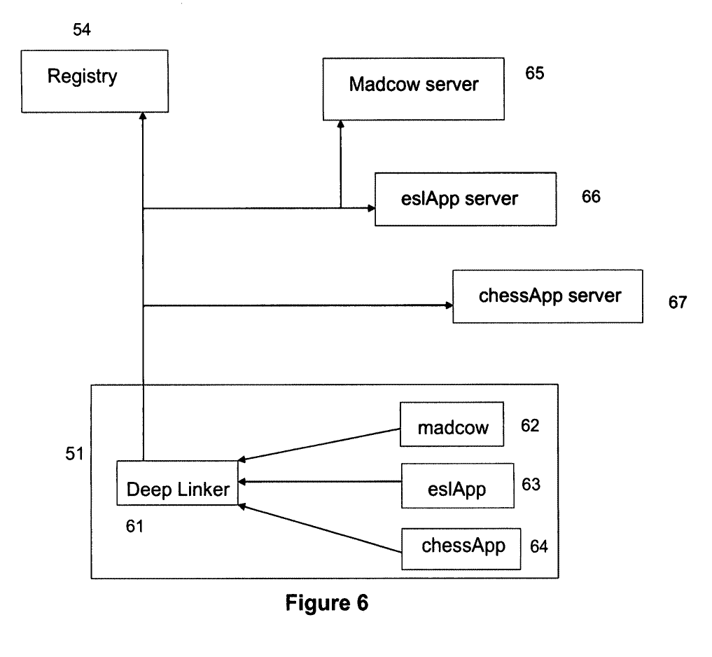

FIG. 6 depicts this. It is an elaboration of FIG. 5. It shows Jane's mobile device 51 from FIG. 5. Device 51 contains Deep Linker 61 and 3 apps, madcow 62, eslApp 63 and chessApp 64. Each app has an associated linket recorded at Registry 54. Jane owns those linkets. So in this sense, the app instances 62, 63 and 64 are “servers”. They are waiting for interaction requests across the network. Even though each instance is a client instance of an actual app server. This can be a potential source of confusion for readers. The reader is urged to understand that Jane device 51 in FIGS. 5 and 6 is the device that acts as a server in the context of linket use.

Of course, Jane might use her device 51 to contact linkets being sourced or served from other devices. In this case, her device is acting as a linket client, while also acting as a linket server. As a point of terminology, we say that Jane's device 51 is a “linket server device” or a “linket owner device”. In the latter phrase, the “owner” means both that Jane owns the device and she owns the linket.

At some earlier times, before Jane moved in FIG. 5, the apps contacted Deep Linker 61. After Jane moved in FIG. 5, Deep Linker 61 then updated Registry 51. But it also sends the new address to madcow server 65, eslApp server 66 and chessApp server 67.

It might be asked. If the Registry and the app server are being updated, why update the latter? As far as an end user using the linket, this might not be necessary. But in general an app server might want to know the latest network location of its instances. So that it might contact them for various reasons.

Also, given a existence of a linket pointing to an instance of an app, it can be useful for the app server to also know the linket. For example, the owner of the linket may be a “power user” of the app. She is proficient in the app and can recruit other users to it. The app server very much should want to know and be able to contact her, to help her recruit more users.

Related to this, in FIG. 6 there could be the case where the Deep Linker sends extra information to an app server, compared to what it sends the Registry. For example, an app server might want some actual geographic location data about the device, not just the new network address. The API that the apps used to contact the Deep Linker might let an app tell the Deep Linker to do this.

A second merit of not having the app do the update is that it factors out some complexity in writing the app into the operating system. Reducing the chances of bugs in the app. There could be an Application Programming Interface (API) exposed by the Deep Linker or operating system. The app uses this API to indicate that it wants the program running the API to handle the address updating. The app uploads whatever necessary lower level details are needed via the API. Reducing the cognitive workload on the programmers.

A variant of the above is where the app server is told by the device of an address change, but the device does not tell the Registry. The app server might tell the Registry. This is shown as step [3] in FIG. 5. There could be various protective encryption steps in the communication between the app server and the Registry.

How does the app server know that the device on which its app runs does not tell the Registry of a new address? The programmers who programmed the app server know the source code of the app. Perhaps the app does not contact the Deep Linker (or any other program on the device) to update the address. And the app does not contact the Registry. The app and its server were designed so that only the app server will relay the new address to the Registry.

One partial reason could be that the above functionality on the device, outside the app, does not exist.

From the Registry's perspective, the previous discussion is the easy case. The Registry is told about address changes from the linket owner devices or the app servers. But what if it is not, for some linkets or app servers? The Registry has to take the initiative.

First, we describe cases where the Registry just does the previous steps. When the Registry gets a linket, it maps in its database to the deep link and gets the app id. If the app server for this app regularly tells the Registry of changes to the addresses in the deep links, then the Registry does not have to verify the addresses. Unless of course the app server appears to be offline. So the Registry could periodically poll the app server just to test this case.

The Registry could update the address in a linket in various ways. Suppose it gets a query from an end user device that submits a linket (“gamer Jane”). This maps to the deep link madcow://10.11.12.13 in the Registry database. Before returning any result to the device that made the query, the Registry could test the deep link to see if there is a program at that address actively listening. The app that presumably is listening at the network address (and a given port) will reply. Thus a useful feature of the app is that a query to the app can be the equivalent of an Internet ping. The query might have an argument that designates that it just wants a simple reply indicating existence, and that nothing else has to change in the internal state of the app. Given this, the feature can be used by the app server or any other entity on the network, to query the app instance.

If there is no reply, then as described in submission 13 for transient deep links, the Registry could ask the madcow server for the latest address it has on record for that deep link. Assuming that the madcow server has this and returns a value to the Registry, then the Registry can do the following steps.

It can check by pinging the deep link from the madcow server. Assuming the Registry gets a reply from the app instance, then the Registry sends the updated deep link to the remote device that sent it the linket. Then it updates its internal database with the new address in the deep link. Just like the app server handled transient deep links, the Registry follows essentially the same procedure. The Registry maintains a table for the deep link of expired addresses. The expired address 10.11.12.13 goes into this table, Expired 43 in FIG. 4.

In future, if the Registry gets another query with the same linket, it looks up the deep link in its database, without actually going out on the network to that address.

The Registry can have a policy of how long it looks up its internal database, before it checks by querying the address. It could use various heuristics, so that different linkets or different underlying apps or different underlying addresses are used to determine the duration. For example, it might find that for some apps, the users who own linkets and deep links seem to be at addresses stable over several hours. So it might have an update period of say one hour.

Another might be that the Registry notices that for some network addresses, which it maps to locations, that at the night times for those locations, the addresses in the deep links rarely change. Possibly the users are asleep. So the Registry might not update during the local times of 11 pm to 7 am.

An important case is where the Registry lets the owner of a linket define days and times when she will be active with her linket. In other words, when she will respond to a query to her deep link. She can define a range of days in the week (eg. Monday to Thursday) and times in those days (eg. 8 am to 6 pm) in her local time zone. She might define exceptions to those ranges. So if her birthday falls on a given Tuesday, she will not be available on that day, for example. She can do this when she first registered her (linket, deep link) with the Registrar. And she can update this later.

This property of a linket being only available at certain regular times is a major difference between a linket and a hosted web domain. The latter has a web server answering queries and most domains are available all the time. When a web domain is unresponsive to a browser query, this is generally considered a problem. The web server has crashed or it is overloaded with queries. But for linkets, where a major use is expected to be a human interaction via apps, there is a need for scheduling of availability. Downtime can be a normal and expected phenomenon of linkets.

Suppose a user, Mike, sends a linket to the Registry, asking for its deep link. If this happens during the downtime, the Registry can reply with the next expected time when the owner, Jane, will be available via the linket, along with the deep link. Or the Registry can reply with her timetable for the next few days.

If a user makes a linket and registers this with the Registry, she might preferably propagate just the linket. Since the underlying deep link might vary and is hard to remember. Or she can propagate both the linket and the corresponding deep link, where the latter could change over time as she and her mobile device move.

The scheduling of linket availability can be taken further. We earlier supposed that Jane works from Monday to Thursday. Perhaps she is a freelancer and during Monday to Wednesday, she can be at various locations, with her mobile device. But suppose that on Thursdays, she works at a fixed location, where she can use the same PC, at an internet address that will be the same from week to week. Imagine further that for this PC and its operating system, there is an app (not a mobile app because the PC is not mobile) for teaching ESL with more functionality than her ESL mobile app. Or the PC app has more bandwidth and more memory.

In narrative simplicity, we assume that when Jane teaches ESL, she uses the same app as her students. Of course there might be different and complementary apps, for student and teacher, in other cases. In the present case, we can imagine that the app starts up in student mode by default, perhaps because most users might be students. But the user who will be the teacher might access some graphical option in the user interface that lets her pick the teacher role. We omit any accompanying diagram of the user interface because we expect that this is a straightforward point for the reader to understand.

For whatever reason, Jane prefers that on Thursdays she teaches ESL on that PC with that app. Even if she has her mobile device with her at those times. In her timetable that she sends to the Registrar, she defines that on Thursdays, her linket maps to a deep link that points to the PC and the PC app.

There is a difference between a linket and a domain name. Suppose we have an URL http://somewhere.com that uses the domain somewhere.com, and the URL is associated with a label “A place to go”. In a web page, the label would be shown, and if the page is seen in a browser and the mouse is over the link, the URL appears at the bottom of the browser. But for a linket, it might be propagated without the underlying deep link. So there might be nothing shown when the mouse is over a linket.

When we described the Registry, for simplicity it was considered as one machine. In practice, the Registry is likely to be a distributed system of servers. For redundancy (in case any crash) and for responsiveness. The latter is improved when a Registry server is close to a device making a query to it. There are well known techniques used by Content Delivery Networks (CDNs) and by the Domain Name System (DNS) that can be adapted to make a network of Registry servers. Another consideration is that the Registry could be a federation of independent servers, perhaps run by different companies. Some Registries might be for and be in certain geographic regions. Where these regions are countries, for example.

### 1.3: Prior Art;

Earlier we described what the prior art means by “deep link”. In that context, the usefulness of a label that points to a deep link is very limited. That deep link has an id of a mobile app and a position within the database of the app. Even if a user could make a label that points to this deep link, this amounts to the label roughly being a bookmark in the context of a web browser. There is little intrinsically in the label that can relate back to the user who made the label. The position in the database points to data owned by the app company. In general, that data has nothing to do with the user, and cannot be altered by her.

Whereas our linket, pointing to our deep link, inherently points to both the user's expertise with an app and to her device network location. The next section expands on what can be done with a linket, from the perspective of the owner.

Our earlier submissions described many differences between the prior art deep link and ours. Here, going further, we show that our concept of a linket has no useful analog in the prior art deep link. There is a practical and conceptual barrier. Someone knowing only the prior art deep link cannot get to our idea of a linket unless she first invents or understands what we have earlier defined for our deep link. A linket is not obvious in the prior art deep link.

Another way to see this is to refer to FIG. 1. Item 11 is an example of the deep link in the prior art. Item 11 has nothing that refers even implicitly to a person. Item 11 has an id of an app, bookseller5, which in general is not associated with a specific user. And the data to the right of the “://” delimiter is a serial number of a book. Again, this also is not associated with a specific user. Essentially, all of the deep link of item 11 belongs to the app company that made the app.

By contrast, see item 12. It is an example deep link of this submission. The network address is (even if only temporarily) the address of the user device that runs an instance of the app. Hence the address in the deep link is by extension, associated with the user. From this user association flows the ability to brand the deep link with a linket label owned by the user.

### 2: Why Own a Linket;

Why would a user own a linket? Consider Jane who teaches English as a Second Language (ESL). She might have a linket “Jane Doe (ESL Expert)”. This becomes her global brand. It might map to an app eslTeach that has versions on Android and Apple. Over time, if she finds a different and better ESL app, she contacts the Registry to replace the app in her deep link with the id of the new ESL app. So she is not tied to the vagaries of a given app. She maintains and can improve the value of her personal brand.

Suppose Jane knows French and Spanish. She might have linkets in those languages, with descriptions also in those languages. She could link her above linket and these linkets to the same deep link. Analogous to how the owner of several domains could tie them to the same IP address.

Another example could be Deepto, who is good at playing a multiplayer game, FastDriver. He has a linket “FastDriver Deepto top dog”. This maps to a deep link that has the app FastDriver. Here, he explicitly ties his linket to the name of a commercial product made by another entity. If the game is popular, having its name in his linket improves the ease of others finding him when they search for players of that game.

There is an analogy for gaming that goes back to the early 1980s and video games. A game machine might have a list of top scorers for that machine. A person could if she qualified write her nickname. The problem was that this was limited to each physical machine. A further step was made in the 1990s when game consoles were networked to game servers. Players could see the top players globally in a game, when they logged into the server.

This example also brings up the possibility of cybersquatting. This phenomenon existed with domain names, where someone might get a domain that had a substring with a trademarked name. Anticybersquatting laws have largely eliminated the problem. Similar statements can be made about linkets. In this example, the owner of the “FastDriver” trademark would likely consent to Deepto using the trademark as part of the linket. The linket is promoting the use of the app described by the trademark.

These examples describe a person using a linket for professional reasons and another person using a linket for recreational reasons. Though if Deepto is good enough at that game, and the game is popular, he can use the linket to promote his career, just like Jane.

A person who has a linket for professional reasons could have another linket for personal activities. Just as though she had several conventional domains. Or she could have several professional linkets and several personal linkets.

An owner of a linket could promote it on social media, like on her social network page. She might put the linket on her printed business card. And as part of her electronic signature when she sends emails. On her own domains, she might list her linkets.

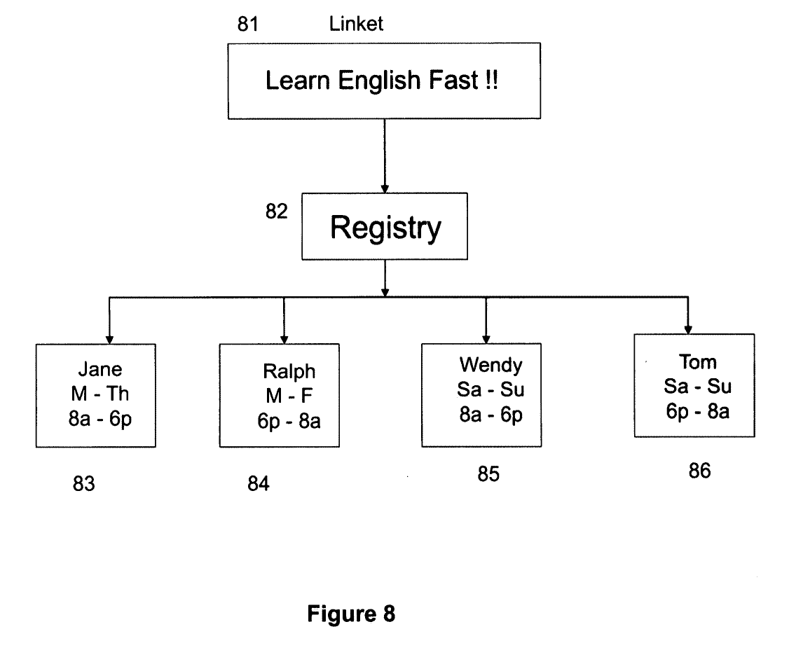

Several people can own a linket. For example, they can combine to teach a skill with as close to 24 hour coverage, 7 days a week, as possible. See FIG. 8. It shows a linket item 81, “Learn English Fast !!”. A user sends this to Registry 82. If the query is from Monday to Thursday 8 am to 6 pm (in some time zone), then the Registry returns the deep link for item 83, where Jane teaches ESL. But if the query is from 6 pm to 8 am on Monday to Friday, the Registry returns the deep link for item 84, where Ralph teaches ESL. While for Saturday to Sunday, from 8 am to 6 pm, Wendy's deep link 85 will be called. And for 6 pm to 8 am on the weekend, Tom's deep link 86 will be called. In practice, for such coverage, these people could be in different time zones. But all the times are given with respect to a particular time zone, for simplicity.

The utility of this matches the possible global nature of a marketplace. If the expected customers hail from all over the world, the linket and its Registry lets a group of people easily cooperate as a small firm to serve global clients.

### 2.1: Auctions;

A key variation on several people owning a linket is where one person, Laura, owns a linket, and she rents it out to others in time slots. Laura owns and controls the linket record at the Registry. She defines what deep link the linket maps to, at different times of the day, week or month. Suppose she has a linket with a popular name, of some semantic value in one or more languages. Like “ESL for All of Us”. (Analogous to owning the domain business.com, for example). She has something of scarcity and hence of value. She can put various time slots out for auction. Perhaps on a conventional website or in an auction app. Bidders bid for each slot. A winning bidder, Jim, for a slot would get the right to determine the deep link, which would presumably map to a device owned or controlled by the bidder. So during that slot, Jim can get whatever business that is garnered via people visiting the linket.

This auction process can be largely or entirely automated. So after a winning bidder for a slot pays his payment (probably electronically), the auction program submits the bidder's deep link to the Registry for that slot.

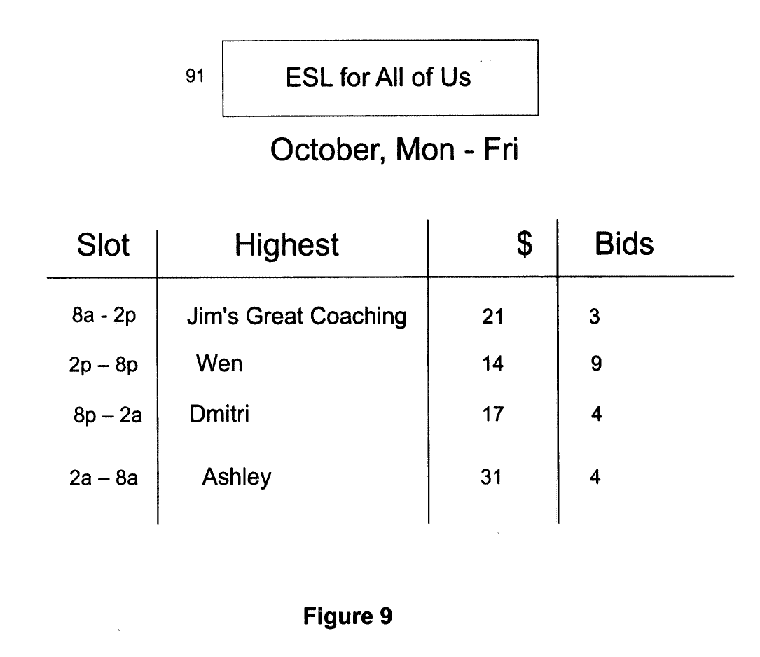

FIG. 9 shows an example. It depicts a bidding screen in a web page or in a bidding app. Item 91 is Laura's linket, “ESL for All of Us”. The label beneath it, “October Mon-Fri” means that she is auctioning slots for the month of October, for each of the weeks with Monday to Friday. She has defined 4 slots, 8a-2p, 2p-8p, 8p-2a, 2a-8a. These are hours in her time zone.

It is a trivial matter for whoever is viewing this screen to use a graphics option (not shown in FIG. 9) to adjust the times of the slots to his time zone. Likewise the English words in the figure could be replaced by translations in other languages. There could be a drop down menu of display languages. To make it easier for others to see and to bid.

What the slots mean is that the winner of the 8a-2p slot commits to answering queries about ESL for all the weekdays in October, during that slot in each weekday. Likewise for the other slots.

FIG. 9 shows an auction in progress (or perhaps a resolved one). The Highest column shows the name of the higher bidder for that slot. Here, it can be supposed that during the process when a bidder entered his bid, he had to put in his name or some label (see next section), which is shown in this column.

The $ column shows what that bidder has bid. If the bidder wins the slot, this dollar value is what he would pay Laura. The value might be per day, or per week or the total for October. There could be some graphics option in the screen to show the appropriate number for the appropriate period. The Bids column shows the number of bids for this slot. When the auction closes, the winning bidder in each slot would pay Laura. Then they might be able to keep all the revenue from the lessons they teach during their slots. Of course other arrangements are possible, like where Laura also gets some cut of their revenue.

We might imagine that Jim is likely to be in the same time zone as Laura, like US Central Time zone. Or at least in the continental US. While the other high bidders are bidding for slots when they would typically be awake. They might be overseas.

The screen of FIG. 9 might let the user click on a cell in the bids column to see the list of bids for a given slot. And there could be an option to let her bid for a slot. So the user could be a bidder or the owner of the linket.

The reader can readily imagine more complicated scenarios than FIG. 9. But it illustrates how a linket owner might derive revenue from ownership, by subcontracting or outsourcing on a global basis. Especially if the ultimate end user base is global.

A refinement can be added. Instead of each linket owner writing her own auction program, the Registry can furnish its own auction program. It takes a cut from the payments. A rough analogy can be Google's auction process for determining which paid ads appear for keywords in searches. It is Google's major source of income. In part, the success comes from Google being able to fully automate the process, with human intervention only for exceptional cases.

Suppose during the slot that Jim won, he gets a customer Mary. He interacts with her via his device. After his slot expires, he can still interact with her, since her device has his device address. And during the slot time, he might have exchanged messages with her, giving his contact information. So even after their interaction ends, she might in future directly contact him, bypassing the linket. This is normal and unavoidable.

An analogy is a person going on the Amazon website to buy from a seller. The buyer and seller communicate via emails that traverse inside Amazon. These emails use temporary email addresses set up by Amazon. Deliberately Amazon hides the actual email addresses of the buyer and seller from each other. Likely in part to avoid them cutting Amazon out of a transaction. However, if a transaction happens, and the seller sends an item in the mail to the buyer, the package can have the seller's contact information. And the seller has the physical address of the buyer. Hence they can bypass Amazon if they wish.

This method of renting out time slots for a linket has no equivalent for domains.

When Jane picks a winning bidder from FIG. 9, it might not entirely be done based on the highest bid. She might also use the reputations (if any) of the bidders. So a bidder with a second highest bid that has a reputation better than the highest bidder might win the bid. The program that makes the display in FIG. 9 might have options that detect if, say, where scenarios like this. If such is detected, the display might show an alert indicator. So that Jane can decide if she want to pick based on not just the bid amount. The ordering of the bids by the amount could be the default ordering.

### 2.2: Linket Pointing to a Linket;

The above discussed where Laura's linket, “ESL for All of Us” points to different deep links, for different days and times of day. An important extension is where the linket points to another linket. Analogous to symbolic links in the unix and linux (and other) operating systems. The point here is that just as Laura's linket has some presumed brand value, it would also be useful if a winning bidder for a time slot had his own linket, with some other brand or semantic value.

Hence a linket can point to one of a deep link exor a linket. In turn, the latter linket might point to a deep link exor another linket.

In FIG. 9, the high bid for the 8a-2p slot has the value “Jim's Great Coaching”. This could be the value of a linket owned by Jim. While the other slots might not be showing linkets but the names of the bidders. Those slots have bidders who do not have linkets. Or at least are not bidding using their linkets, if they have linkets.

### 2.3: Space and Time Slots;

Earlier we described how a linket owned by Jane could map to different deep links or linkets, based on time slots. A winner of a time slot would get queries from all over the world that went to Jane's linket. Another approach is spatial slots. Jane's linket maps to different deep links or linkets based on the location of the address that the query is coming from. The location can be estimated by at least one or two means. First, when the app on the device asks the Registry, the app might upload its location, where the app gets the location via GPS or some other means. Second, the Registry can take the network address that the query is coming from, and try to map that to a location. The address is likely a temporary one, owned by the wireless access point or the wireless phone carrier.

The first is more accurate. The second might be known only down to the resolution of the town or other area. This might still be sufficient for the Registry to map to an appropriate responder for the region.

Jane's linket might map based on both space and time slots. So she might auction off a time slot of 8a-2p in 4 regions. North America, South America, Europe/Africa, Asia. So the winning bidder for Asia would have a deep link or linket located in Asia; ditto for the others. This can improve the responsiveness of the interaction between the user and the responder. A user in Asia querying her linket would get a responder in Asia, and not in the Americas. Minimising the geographic distance between them.

More fine grained spatial slots can be imagined. Down to the country level. Or down to regions within a country.

One edge case needs to be treated. Suppose that Jane is unable to fill a slot. Either there were no bidders for it, or she rejected all bidders. Perhaps because none were reputable enough for her. (She needs to protect the rating of her linket.) When a user during the time interval of that slot (and within the spatial region of the slot) queries her linket, the Registry could map it to her own deep link. Where she might put up a screen saying “Sorry, nothing available right now”. Assuming that she cannot fulfill the query herself.

This can also be done for the case where the query happens at a time and place not covered by the slots. For example, if none of the slots happen on a Saturday, and a user queries her linket on a Saturday.

We reiterate that this temporary mapping of a linket to other linkets or deep links, as a function of time and space, is a key distinction between the linket and a web domain. For the latter, there is no commonly accepted practice (as far as we know) where a domain temporarily maps to another address outside the set of addresses owned by the ISP that hosts the domain. And where after some time, the mapping expires and the mapping of the domain goes back to the first address.

### 3: Format of a Linket;

As we explained in section 1, the format of a linket is arbitrary. And in the industry implementation of a linket there might be several formats. Even so, we discuss here several possible formats as illustrative examples.

We can look at existing formats of a domain name, email, URL and the Twitter hashtag as guidance. The main criterion for a linket format is so that the linket can be programmatically detected in a page of text (which may have other markup) that is to be shown in a browser or in a screen of an app. So that the linket can be depicted in this page in some manner indicating to a human reader that the linket is “a linket”. More specifically, the linket can be depicted similar to how a link is shown in a web page. So when the user moves a mouse (or does the equivalent on a mobile device) over the linket, the linket changes visible form. And if the user then clicks the mouse, the linket is executed by the program, to get the underlying deep link and then (typically) install the app and run it appropriately on the user's mobile device.

One possibility is that the linket sits inside XML-style tags. Like

<linket>Jane Doe (ESL Expert)</linket>

Another case can hinge on whether the linket has white space inside it or not. If so, then it needs leading and trailing delimiters, like the above tags. If not, then a more compact notation can be envisioned. Where the leading and trailing delimiters might in part be furnished by standard punctuation of sentences. For example, consider how an URL can be written in a text sentence like this—http://test.com. Here the leading delimiter is a whitespace before the h and the trailing delimiter is the full stop of the enclosing sentence. The actual delimiter is the leading http and the :// that give guidance to a program to then depict the string as a clickable URL. Similarly the Twitter hashtag has a leading “#” character. The trailing delimiter might be a whitespace, a comma, semicolon or full stop from the external sentence.

Given this, one example format of a linket can be [[JaneDoe(ESLexpert), where there is only the leading delimiter of “[[”.

Another choice can be [[JaneDoe(ESLexpert)]], where there are leading and trailing delimiters. But if there are trailing delimiters, then white space can be allowed inside a linket. So we can have [[Jane Doe (ESL expert)]]. The latter is easier to read than the former.

For leading and trailing delimiters, a choice should be unlikely to be already used in many sentences. Using two or more characters (like “[[”) increases the likelihood of this.

In the limit of using a minimum number of delimiter characters, only one leading delimiter might be chosen (and where white space is not allowed inside the linket). For example, % JaneDoe(ESLexpert). Here the percent character acts similar to the hash character in a hashtag. The problem with using a single character is what to use. Letters and digits are not recommended because of likely confusion with existing uses of those symbols. The hash cannot be used, because of the existing hashtags. And so on.

Another context is where the author who writes a linket also wants to explicitly include an associated deep link. We say “an” because the deep link might change with time as the author moves with her mobile device. In this case, XML notation might be chosen to associate the pair. For example—

<linketAndDeepLink>
<linket>Jane Doe (ESL expert)</linket>
<deepLink>eslApp://40.41.42.43</deepLink>
</linketAndDeepLink>

However, there is also the case where the deep link has a domain in its name. Perhaps when a mobile device gets a permanent IP address under IPv6. Or when the device is not mobile and has a fixed IPv4 or IPv6 address. So the previous example might now be—

<linketAndDeepLink>
<linket>Jane Doe (ESL expert)</linket>
<deepLink>eslApp://eslteacher.net</deepLink>
</linketAndDeepLink>

There might be extra optional fields in the above XML snippets. Like a timestamp of when a raw IP address in the deep link was valid. Or of a range of times (like days and hours in a week) when the deep link will be accessible. For example, when the user at that deep link will be “working” by answering any queries to her via the deep link.

We claim:

1: A method of a server, Registry, making an association of a linket with a deep link; where the linket is a string; where the deep link has an identifier of an app; where the deep link has a network address of an instance of the app; where the Registry stores the association in a database.

2: The system of claim 1, where the linket is in Unicode.

3: The method of claim 1, where the Registry gets a query with a linket; where the Registry searches the database; where the linket is in the database; where the Registry replies with the corresponding deep link.

4: The method of claim 1, where the Registry gets a query with a deep link; where the Registry searches the database; where the deep link is in the database; where the Registry replies with the corresponding linket.

5: The method of claim 1, where the Registry gets a query with a linket from an entity Chi; where the Registry searches the database; where the linket is not in the database; where the Registry stores the linket, with no corresponding deep link, in the database; where the Registry records Chi as the owner of the linket; where the Registry stores data about Chi in the database.

6: The method of claim 5, where the Registry charges a fee to Chi to register the linket.

7: The method of claim 5, where the Registry gets a message from Chi; where the message has a deep link; where the Registry associates the deep link with the linket; where the Registry stores the association in the database.

8: The method of claim 7, where the Registry gets Phi messages from Chi over a given period of time; where the messages have deep links; where Phi exceeds a quantity Sigma; where the Registry charges Chi a fee.

9: The method of claim 7, where the linket has an existing deep link Rho; where the Registry records Rho in a list of prior deep links associated with the linket; where the list is stored in the database.

10: The method of claim 5, where the Registry gets a query with an identifier of an app; where the Registry sends a list of linkets; where the linkets have deep links with the identifier.

11: The method of claim 5, where the Registry gets a query with an identifier of Chi; where the Registry sends a list of linkets; where the linkets are owned by Chi.

12: The method of claim 1, where the Registry associates a linket Omega with a linket Kappa; where the Registry gets a query with Omega; where the Registry sends data associated with Kappa.

13: The method of claim 12, where the Registry sends a deep link associated with Kappa.

14: The method of claim 1, where the Registry runs an auction; where the auction is for a time slot for a linket Psi; where the Registry finds a winner for the time slot; where the Registry has a linket Omega, owned by the winner; where Psi differs from Omega; where during the time slot, the Registry gets a query with Psi; where the Registry sends a deep link associated with Omega.

15: A method of an entity using a device; where the entity owns a linket; where the device runs an app; where the device sends a query to a Registry server; where the query contains a deep link; where the deep link has an identifier of the app; where the deep link has a network address of the device; where the query is a request for the Registry to associate the deep link with the linket.

16: The method of claim 15, where the device is mobile.

17: The method of claim 16, where the device records the current network address; where the device is moved; where the device acquires a new network address; where the device sends a query to the Registry; where the query contains a deep link; where the deep link contains an identifier of the app; where the deep link contains the new network address of the device; where the query is a request for the Registry to associate the deep link with the linket.

18: The method of claim 16, where the app records the current network address; where the device is moved; where the device acquires a new network address; where the app sends a query to the Registry; where the query contains a deep link; where the deep link contains an identifier of the app; where the deep link contains the new network address of the device; where the query is a request for the Registry to associate the deep link with the linket.

19: The method of claim 16, where the device sends the linket in an electronic message to a recipient.

20: The method of claim 16, where the device posts the linket to a web page.
